(19) United States
(12) Patent Application Publication
(10) Pub. No.: US 2024/0399366 A1
(43) Pub. Date: Dec. 5, 2024

(54) CENTRIFUGABLE SAMPLE CARRIER

(71) Applicant: Testo bioAnalytics GmbH, Titisee-Neustadt (DE)

(72) Inventors: Markus Munzer, Hinterzarten (DE); Joel Riemer, Breitnau (DE); Robert Rieger, Freiburg (DE); Linda Pfeifer, Villingen-Schwenningen (DE)

(73) Assignee: Testo bioAnalytics GmbH, Titisee-Neustadt (DE)

(21) Appl. No.: 18/417,001

(22) Filed: Jan. 19, 2024

(30) Foreign Application Priority Data
Jan. 20, 2023 (DE) 102023101481.1

(51) Int. Cl. B01L 3/00

(52) U.S. Cl. CPC B01L 3/502723; B01L 2200/0605; B01L 2300/041; B01L 2300/048; B01L 2300/087; B01L 2400/0409

(57) ABSTRACT

A centrifugable sample carrier (1) having a fluidic system (2), the fluidic system having at least one chamber (3, 20, 21, 32, 44, 45, 46, 63) which has at least one inflow opening 4, the chamber (3, 20, 21, 32, 44, 45, 46, 63) having at least two mutually spaced-apart ventilation openings (6, 7), and the ventilation openings (6, 7) being mutually disposed in such a way that a connecting line between the ventilation openings (6, 7) does not run through the chamber (3, 20, 21, 32, 44, 45, 46, 63). A sample carrier (1) of this type is particularly suitable for use in analytical methods for detecting microorganisms, but is not restricted to this use.

### CROSS-REFERENCE TO RELATED APPLICATIONS

This application claims priority from German Patent Application No. 10 2023 101 481.1, filed Jan. 20, 2023, which is incorporated herein by reference as if fully set forth.

### TECHNICAL FIELD

The invention relates to a centrifugable sample carrier having a fluidic system which has at least one chamber, the chamber having at least one inflow opening.

### BACKGROUND

Centrifugable sample carriers having a fluidic system are known from the prior art and are often referred to as a “lab-on-a-chip” system, because they are used for identifying and analyzing microparticles in the smallest space. “Lab-on-a-chip” systems of this type are used in the food industry, the medicine and in pharmaceutical production.

A disadvantage of fluidic systems, in particular micro-fluidic systems, lies in their complex network of, for example, fluidic ducts, pumps and valves which are required for an analytical method. Production costs, in particular in volume production, are relatively high as a result. Furthermore, a complex design embodiment of a micro-fluidic system of a “lab-on-a-chip” system can lead to error sources in analyses, which impede reproducible results. For instance, inter alia capillary forces and surface characteristics of a micro-fluidic system can have a significant influence on measurement results.

The use of fluidic systems, in particular of micro-fluidic systems, for centrifugation necessitates further, in some instances even more complex and more cost-intensive requirements in terms of the material and in terms of the design embodiment of the fluidic system. This is particularly disadvantageous in volume diagnostics, in particular in the industrial sectors mentioned at the outset.

### SUMMARY

It is therefore an object of the invention to improve centrifugable sample carriers with a fluidic system.

According to the invention, one or more of the features disclosed herein are provided for achieving the object mentioned. For achieving the object mentioned in centrifugable sample carriers of the type described at the outset, it is thus proposed in particular according to the invention that the chamber has at least two mutually spaced-apart ventilation openings, and that the ventilation openings are mutually disposed in such a manner that a connecting line between the ventilation openings does not run through the chamber. According to the invention, a chamber can be optimally ventilated as a result, a pressure in the chamber being able to be kept constant or adapted as a result. A constant and/or adaptable chamber pressure can be important in particular in the case of sensitive environmental samples and/or chemicals for testing said environmental samples. As a result, centrifugable sample carriers having a fluidic system can be improved. By using two ventilation openings, the ventilation can be carried out independently of an orientation of the chamber relative to a momentary direction of a centrifugal force, for example.

Depending on the configuration and use of the sample carrier, more than two ventilation openings which are mutually spaced apart may also be provided. Particularly optimal aerating of a chamber can be designed in this way.

In a centrifugable sample carrier according to the invention, the at least two ventilation openings are mutually spaced apart. In this way, air or another gas located in the chamber can advantageously escape from two ventilation openings that are spaced apart, as a result of which ventilation can be implementable in a particularly positive manner, for example independently of an orientation of the sample carrier within a centrifuge. A flexible ventilation of this type is particularly advantageous.

The at least two ventilation openings herein are disposed in such a way that a connecting line located between the ventilation lines does not run through the chamber. As a result, the at least two ventilation openings can be formed on a flat or convex structure, for example a wall, this simplifying the manufacture of the chamber and thus of the fluidic system. Furthermore, a gas can escape in a direction through the two ventilation openings, as a result of which turbulences in the chamber can be minimized or avoided, which is advantageous. The configuration of a flat or convex structure can also be advantageous for avoiding formation of stationary air bubbles between the ventilation openings, should a momentary direction of a centrifugal force from the chamber run between the ventilation openings.

Each type of chamber of a centrifugable sample carrier according to the invention can be configured as described above or claimed hereunder. For example, a metering chamber, a storage chamber or chambers of an arrangement can be configured as described above or claimed hereunder in this way.

In one advantageous design embodiment it can be provided that the chamber has a base in which a depression is formed. The depression herein can be formed, for example, as a pocket or in the shape of a bowl. Liquid which is introduced into the chamber can advantageously be held in the depression. As a result, a liquid, for example an environmental sample to be tested or a compensation substance, can be better checked. Furthermore, processing steps can be performed in the depression in the course of an analytical method. A depression is also a suitable means to keep ready substances, for example in dried form, for wetting with the introduced liquid.

The depression can at least be partially formed by a wall of the chamber, so that the depression can be formed very close to the wall. In this way, a liquid can be held particularly close to a wall of the chamber, this being particularly advantageous during centrifugation of the sample carrier.

In one advantageous design embodiment it can be provided that a wall of the chamber forms a projection protruding into the chamber, that a runoff edge is formed on the projection, and that the inflow opening is disposed between a dripping edge and an impact point of a pouring jet defined by the runoff edge. A liquid can be transported slowly from an inflow opening into the chamber by way of a protruding projection, as a result of which constituent parts of the liquid can be protected. The liquid can be reliably guided by the runoff edge of the projection, which is advantageous.

In one advantageous design embodiment it can be provided that the sample carrier has a main body on which the fluidic system is configured so as to be open toward one side, the main body having in particular at least one fastening blade. As a result, an environmental sample can be fed directly to the fluidic system. In this way, the fluidic system does not have to be additionally removed from the centrifugable sample carrier in order to receive a sample, the analysis of the environmental sample being able to be carried out faster and more reliably as a result. The operation of centrifugable sample carriers can be improved in this way. Such an arrangement also allows a simple production by the injection-molding method, because cavities which are closed on all sides or accessible only by way of a narrow opening are avoidable. The invention has recognized here that the cavities or chambers and the ducts can be closed by a cover.

The open side of the fluidic system herein can be configured in such a way that the opening of the fluidic system is adapted in a form-fitting manner to a sample removal apparatus, in particular to the region containing the sample. Transferring a sample can be implementable in an optimal manner as a result. It can be particularly advantageous that the region containing the sample can remain in the opening even during the centrifugation and/or analysis of the sample. In this way, the side that is configured to be open can be able to be closed at least during the centrifugation and/or analysis of microparticles, for example.

Furthermore, owing to the at least one fastening blade, the sample carrier can be inserted and/or fixed with an exact fit on a sample holder, preferably a centrifuge, as a result of which the sample carrier can be reliably centrifuged. This represents a preferred use of the invention described. The at least one fastening blade can advantageously prevent tilting of the sample carrier and an associated leakage of liquid from the sample carrier, so that further elements of the sample carrier, the centrifuge or other components of an analysis device can advantageously be protected. In this way, the operation of centrifugable sample carriers can be even more improved. Operating errors, for example in the form of the sample carrier remaining unsecured, are thus avoidable.

The fastening blade is preferably configured to be deformable in such a way that, for example, latching (and subsequent releasing) of the sample carrier on/from a corresponding mounting of the centrifuge can be made possible, as a result of which handling of the sample carrier can be particularly user-friendly. A sample carrier which has at least two fastening blades is particularly user-friendly, because latching can be implementable even more reliably as a result, for example.

In one advantageous design embodiment it can be provided that the fluidic system has at least one arrangement of chambers, each chamber of the at least one arrangement being adjacent to at least two further chambers of the at least one arrangement. As a result of an arrangement of this type, different processing steps for analyzing an environmental sample can be performed separately from one another, as a result of which an analysis can be designed to be even more precise and/or more complex. In this way, methods with several steps are possible, this making possible particularly improved operation with centrifugable sample carriers. It is thus in particular possible to achieve arrangements in series and/or branched topologies of chambers.

The arrangement can be configured in a space-saving manner because it can be provided in one advantageous arrangement that each chamber of the at least one arrangement is adjacent to at least two further chambers of the arrangement. As a result, the fluidic system and/or the centrifugable sample carrier can be of a relatively small configuration, this improving a sample carrier.

In one advantageous design embodiment it can be provided that the sample carrier has two sides which are separated by an encircling periphery, the fluidic system comprising a connecting duct which connects the two sides, and the at least one connecting duct at the ends thereof transitioning into in each case one fluidic duct running along one of the two sides. A sample carrier of which the micro-fluidic system can transport a liquid in three dimensions can be formed in this way. A centrifugable sample carrier of this type is particularly improved because more reaction space of the sample carrier for the purpose of analysis can be achieved, which makes possible complex analytical methods with several steps. For example, an analysis region, preferably a membrane, can thus be configured on a different side of the sample carrier than a preparation chamber, a fluidic duct leading to the analysis region and the preparation chamber being connected by a connecting duct. A centrifugable sample carrier can be configured to be particularly variable in this way.

Furthermore, at least one drain for excess liquids can also be located on one side of the fluidic system. An analysis region and a preparation chamber and the inflow opening can be located on the other side of the fluidic system, for example. Since the two sides of the fluidic system are connected to one another by way of the at least one connecting duct, an optimal discharge of excess liquid can thus be enabled, a return flow of liquid, for example into the analysis region, being advantageously able to be prevented as a result.

The encircling periphery can be formed by the disk-shaped sample carrier and/or by the fluidic system, as a result of which the encircling periphery is produced in a cost-effective and time-saving manner conjointly with the sample carrier and/or the fluidic system. For example, a sample carrier which has two sides can be integrally produced in this way. As a result, a sample carrier can be configured to be more stable, this being particularly important when the sample carrier is centrifuged.

In general, the disk shape of the sample carrier can have a contour which is round, oval or angular (polygonal) or delimited in a rectilinear or curvilinear manner.

In one advantageous design embodiment it can be provided that the fluidic system has at least one metering chamber and a storage chamber, a connecting line between an inlet opening of the storage chamber and an outlet opening of the metering chamber running through the storage chamber. As a result of a metering chamber, which is disposed downstream of the storage chamber, the fluidic system can advantageously be filled or purged with compensation substances such as, for example, buffer solutions or water.

Furthermore, an identical volume of a compensation substance can be released in a repeatable manner by a metering chamber. In this way, an identical volume of a compensation substance can be fed to each region, in particular each chamber, to the fluidic system, as a result of which reaction conditions of one or a plurality of chambers can advantageously be better checked. Operating a sample carrier can be particularly improved as a result, in particular also when the fluidic systems has an arrangement of chambers in which methods with several steps can be implemented, as described above or claimed hereunder.

The storage chamber advantageously enables that a compensation substance is disposed upstream of the metering chamber.

Targeted metering of a chamber of the fluidic system is possible in particular in a centrifugable fluidic system as a result of the design embodiment according to the invention, a connecting line between an inlet opening of the storage chamber and an outlet opening of the metering chamber running through the storage chamber. In this way, the storage chamber can preferably obtain a compensation substance by way of the inlet opening of the former, when the sample carrier is moved about a rotation axis. Likewise, the metering chamber can also release the compensation substance into a chamber as a result of a targeted rotating movement. In general, metering chamber (and the outlet opening thereof) and storage chamber (and the inflow opening thereof) can be disposed in such a way that metering of a chamber with a compensation substance can be performed either during a rotation of the sample carrier in the clockwise direction or in the counterclockwise direction. In this way, valves or other complex movable components can be dispensed with for active metering of a chamber, as a result of which costs and complex design embodiments of the fluidic system can be saved. Furthermore, releasing a compensation substance can be performed repeatedly, which is advantageous.

In one advantageous design embodiment it can be provided that the fluidic system has a measuring region, wherein the measuring region is closed by a removable cover element. As a result, the measuring region can be covered and sealed, this being advantageous during the centrifugation and/or the analysis of an environmental sample. A tight cover is also important from the point of view of hygienic or operational safety aspects.

A removable cover element can be understood to mean a cover element which is able to be permanently removed from the measuring region at least while recording an environmental sample. In the case of a removable cover element it can be advantageous that the fluidic system can be closed and sealed by the cover element when transferring a fluid into the measuring region. Additionally, recording an environmental sample can be improved by a removable cover element to the extent that the cover element is not positioned so as to interfere between microparticles of the environmental sample and a detector, for example.

The removable cover element is preferably configured in such a way that devices, for example a detector, are not impeded by removing the cover element for opening the measuring region, which is advantageous. In this way, a measuring region having a transparent cover element can be used, for example, for detecting fluorescent microparticles located in the micro-fluidic system. In general, a measuring region can be conceived in such a way that optical recordings of the environmental sample located in the fluidic system are in particular able to be carried out.

The measuring region can be the analysis region described herein. In this way, the measuring region can advantageously be located in a measuring chamber as described hereunder, which comprises a membrane as preferably described herein. The at least one inflow opening can be formed by the previously described connecting duct, as a result of which a connection to the preparation chamber described herein or to any other chamber can advantageously be implemented, this being particularly advantageous when the measuring chamber and the preparation chamber/chamber are located on different sides of the sample carrier.

In one advantageous design embodiment it can be provided that the measuring region is located in a measuring chamber. In this way, the measuring region can advantageously be fed with a sample liquid and/or compensation substance to be tested. The measuring chamber herein is advantageously configured in such a way that a sample liquid, or a compensation substance, is optimally prepared or able to be prepared for analysis.

Alternatively or additionally, the measuring region is connected to at least two waste chambers. The measuring region and the two waste chambers here are disposed in the fluidic system in such a way that the liquid flows out of the measuring region during the centrifugation and pivoting of the centrifugable sample carrier, so that no liquid remains in the measuring region, in particular on the membrane already described. In this way, the measuring region can be fed sequentially with a plurality of preferably different liquids without there being any mixing of the liquids in the measuring region. Furthermore, a backlog in the measuring region and/or in the measuring chamber can be avoided. Analyses and/or measurements of samples can in particular be improved in this way.

For instance, it can be provided in particular that the overflow duct leading to the first waste chamber of the at least two waste chambers opens out on a side of the measuring region other than the overflow duct of the second waste chamber of the at least two waste chambers. Furthermore, these two overflow ducts, in particular proceeding from the measuring region, are routed at an angle which is in particular at least 90°. It is provided in particular that the two overflow ducts are routed at an angle so that the latter after pivoting of the sample carrier have a gradient, so that the liquid is transported from the or a chamber to only one of the waste chambers by way of the measuring region. It can thus be prevented that liquid remains in the measuring region, because liquid from the measuring region can flow into at least one of the two waste chambers while the sample carrier is centrifuged and pivoted.

Alternatively or additionally, the measuring region is connected to at least two waste chambers. In this way, liquid from the measuring region can be discharged independently of an orientation of the sample carrier. In particular one of the at least two waste chambers herein can be connected in front of the or a measuring region, in particular in a processing direction. The sample carrier can be configured in a space-saving manner in this way.

Alternatively or additionally, one of the at least two waste chambers is connected behind the or a measuring region, in particular in a processing direction. The sample carrier can be configured in a space-saving manner in this way.

If one of the two waste chambers is formed in front of the measuring region, and the second of the two waste chambers behind the measuring region, it can be ensured, independently of the orientation of the sample carrier, that no liquid remains in the sample carrier.

The processing direction can in particular be understood to mean a direction of a centrifugal force.

In one advantageous design embodiment it can be provided that the measuring chamber is releasably connectable to the sample carrier. The measuring chamber herein, as a separate component, can be releasably connectable to the sample carrier by way of a snap-fit closure or a plug-in closure, for example. This offers the advantage that the measuring chamber can be disposed of and/or lifted independently of the sample carrier. This also offers the possibility that further analyses of the sample contained in the measuring chamber can subsequently be carried out if required. Moreover, a measuring chamber which is particularly suitable for the respective analysis can also be connected to the sample carrier in this way. This offers a higher degree of flexibility when using the sample carrier.

In one advantageous design embodiment it can be provided that a buffer chamber is disposed in fluidic connection between at least one of the at least two waste chambers. In this way, the fluidic system can readily be pivoted counter to the centrifugal force while liquid flows through the measuring region or the measuring chamber. This results in a liquid flow between a chamber, which transfers liquid into the measuring region or the measuring chamber, and the buffer chamber. This liquid flow, referred to as a crossflow, can advantageously be utilized for crossflow filtration. Blocking of the membrane or of the measuring region can be decelerated or even prevented by the crossflow. Furthermore, the crossflow can in particular be utilized to accelerate reactions on the membrane so that analyses of samples can be improved.

In one advantageous design embodiment it can be provided that at least one of the ventilation openings transitions into a ventilation duct which preferably has a change of direction in its course. A gas for ventilation can advantageously escape from the at least one chamber by way of a ventilation duct in this way. The change of direction is preferably configured in such a way that space can be saved in the fluidic system. It can furthermore be advantageous in a ventilation duct which has a change of direction in its course, that the change of direction is configured or oriented in such a way that a gas can be moved through the ventilation duct in an optimal manner when filling the chamber, in particular during centrifugation.

In one advantageous design embodiment it can be provided that at least one corner is formed between at least one ventilation opening and the inflow opening. As a result, at least one of the ventilation openings and the inflow opening can be implemented on different walls of the chamber. This is advantageous for ventilating and/or filling a chamber to the extent that ventilation openings and the or an inflow opening can preferably be positioned at different, in particular vertical, positions of a chamber. In this way, a volume of a chamber can be optimally utilized, as a result of which further chambers and connecting ducts can be saved, the fluidic system being able to be produced in a relatively simple and cost-effective manner as a result.

In one advantageous design embodiment it can be provided that the at least two ventilation openings converge. It can thus be provided that each of the two ventilation openings has a ventilation duct as described above or claimed hereunder, wherein both ventilation ducts converge. The production of a fluidic system can be simplified in this way, because fewer microstructures and less space have to be occupied.

Ventilation openings which converge at an acute angle are particularly advantageous, because even more space can be saved, in particular when the angle is particularly acute.

In one advantageous design embodiment it can be provided that the chamber has at least one overflow opening which transitions into an overflow duct. In this way, overflowing liquid can escape from the chamber through the overflow opening and the overflow duct, this being advantageous because a return flow through the inflow opening can be avoided in this way. The maximum filling volume of a chamber may also be defined by the positioning of an overflow opening, this potentially being particularly advantageous for regulating the pressure of the chamber.

The overflow duct can connect the chamber to a waste chamber and/or a holding chamber into which liquid would be transferred if too much liquid were filled into the chamber. A liquid can be disposed of and/or held in this way.

The overflow opening is preferably positioned above the inflow opening. This can be implemented in that, for example, the overflow duct is separated from a primary volume of the chamber by way of a feed duct. It can be advantageously guaranteed in this way that no valuable sample liquid and/or compensation substances are lost.

In one advantageous design embodiment it can be provided that the inflow opening is configured as an inflow region. In this way, the inflow region can function as the previously described feed duct, as a result of which no further structure has to be incorporated in the fluidic system, which can save even more space and costs.

The inflow region herein can be designed in different ways in order to be able to optimally receive liquid. For example, the inflow opening can thus be configured to be narrower toward the chamber than the remaining part of the inflow region. As a result, liquid can be collected before entering the chamber and be transferred slowly, as a result of which bubbles can advantageously be avoided.

It can be particularly advantageous for the overflow opening to be located above the inflow region. In this way, a particularly large amount of space and costs can be saved, because the inflow opening and the overflow opening are thus formed on the inflow region.

In one advantageous design embodiment it can be provided that at least one fluidic duct connected to the or a chamber has a siphon-type profile. In this way, a liquid can be guided out of the chamber when the sample carrier rotates. For example, a siphon-type overflow duct, as described above or claimed hereunder, can be used for transmitting a liquid overflowing from the chamber even when the centrifugable sample carrier is rotated about a second rotation axis. A sample carrier can be particularly effectively utilized in such a way.

Moreover, extra fluidic components, preferably for directing the liquid, can be dispensed with on account of the siphon-type profile of a fluidic duct, this potentially simplifying and accelerating the production of a fluidic system.

In one advantageous design embodiment it can be provided that the or a chamber has at least one concavity protruding into the interior of the chamber. As a result, an external contour of the chamber can be of a concave configuration. Furthermore, the chamber can be subdivided into at least two compartments by a concavity, as a result of which a separation of the or a liquid can be performed in the same chamber, which is advantageous.

The at least one inflow opening and/or the at least one ventilation opening herein are/is preferably positionable between the concavity and a centrifugal axis. It can be prevented in this way that a liquid flows out and/or back in an uncontrolled manner by way of a ventilation duct and/or feeding fluidic duct. In this way, other segments of the fluidic system and/or of the sample carrier can be protected in relation to liquid.

The inflow opening and the at least one ventilation opening herein can be disposed on opposite sides of the concavity so that liquid cannot exit in an uncontrolled manner through a ventilation opening and/or inflow opening even when the sample carrier is pivoted, in the clockwise direction for example.

It can also be provided that an arrangement consisting of ventilation opening, concavity and inflow opening prevents liquid exiting a chamber even when the sample carrier performs a pivoting movement in the counterclockwise direction.

In this way, chambers, preferably waste chambers and holding chambers, can be designed to be particularly leakage-proof, this improving fluidic systems of centrifugable sample carriers.

In one advantageous design embodiment it can be provided that the chamber is connected to an antechamber by way of the inflow opening. In this way, a liquid can be transferred into the chamber by way of the antechamber. The design embodiment and positioning of the antechamber is optimally adapted to the chamber so that the chamber can be filled during the centrifugation.

For instance, the antechamber can preferably have a friction wall with the gradient decreasing toward the inflow opening. As a result, a liquid can flow along the gradient to the inflow opening of the chamber during the centrifugation, as a result of which the liquid can advantageously be transferred more slowly into the chamber. Turbulences in the liquid can be minimized or prevented in this way.

The antechamber can be formed within the arrangement of chambers described above or claimed hereunder, as a result of which a particularly compact centrifugable sample carrier can be formed.

In one advantageous design embodiment it can be provided that the depression is disposed opposite an inflow opening. As a result, a liquid entering by way of the inflow opening can be transferred to the depression by way of a relatively short path and held in said depression. Furthermore, not only space can advantageously be saved as a result, but also the inflow of the liquid by way of the inflow opening and the filling of the depression can be synchronized, which may reduce processing times. The latter is particularly important when processing steps, as described above, are carried out in the depression.

Alternatively or additionally, it can be provided that the depression is disposed in the chamber defined by a wall in such a manner that a minimum spacing of the depression from the inflow opening is greater than a minimum spacing of the depression from the wall. In this way, a depression can also be disposed so as to be spaced apart from the inflow opening and from a wall of the chamber, as a result of which a depression can be flexibly adapted to the dimensions of a chamber, which is advantageous.

In one advantageous design embodiment it can be provided that the depression is filled with a preferably dried substance. The dried substance herein can contain constituent parts which are required for detecting microparticles. In this way, at least one DNA marker molecule for specifically detecting microorganisms can be kept ready as the dried substance or as part of the latter in the or a depression, for example. The dried substance can then be activated by a liquid (for example a compensation substance) which is transferred into the chamber, such that a processing step, as described above, can advantageously be carried out.

As a result of depressions with an inventive concept, thus those depressions described above or claimed hereunder, different and/or complex method steps can be carried out with a centrifugable sample carrier. For example, the most varied detection methods for microorganisms can thus be carried out on a centrifugable sample carrier.

In one advantageous design embodiment it can be provided that the inflow opening is disposed on a free end of the projection, or that the inflow opening is disposed in a vicinity of a foot of the projection. It is advantageous here that the or an inflow opening can be formed on different regions of the projection, as a result of which a projection can be positioned variably in chambers.

In one advantageous design embodiment it can be provided that the open side is formed as a receptacle region for a sampling instrument. In this way, an environmental sample of the fluidic system of the centrifugable sample carrier can advantageously be fed in without the fluidic system and/or centrifugable sample carriers having to be additionally opened. This is particularly advantageous when highly sensitive detection methods (for example of microorganisms) are carried out, in which potential sources of interference, such as contaminations, are to be avoided.

The receptacle region herein can be implemented with an exact fit for a configuration of a sampling instrument, so that a sample can preferably also be retrieved during centrifugation.

In general, the receptacle region can be closable in relation to the outside in such a way that no environmental sample and/or a liquid can leak outward. In this way, the environmental sample and/or an apparatus located outside the sample carrier can advantageously be protected.

It can be provided in particular that a purging opening is positioned at a spacing between an exit of the receptacle region and a drain of the receptacle region. A compensation substance, for example a buffer solution, can be fed to the environmental sample by way of the purging opening, as a result of which sensitive components of the environmental sample can be advantageously protected and/or be prepared in a method step for an analysis.

Furthermore, a compensation substance entering by way of the purging opening can ensure an optimal removal of the microparticles, in particular of microorganisms, from the sampling instrument, this being potentially particularly important when quantifying microparticles.

In one advantageous design embodiment it can be provided that the receptacle region has a notch. The notch can be formed in such a way that a sampling instrument can be more easily broken on said notch, so that a fragment of the sampling instrument without the sample can be reliably removed. The fragment of the sampling instrument located in the receptacle region can furthermore be held in the receptacle region by the notch, which is advantageous. In general, a notch can improve the supply of an environmental sample to the fluidic system and/or to the centrifugable sample carrier.

In one advantageous design embodiment it can be provided that the main body has a wall which delimits the fluidic system. The fluidic system can be protected in relation to external influences in this way.

It can be provided in particular herein that a wall thickness of the wall is at most one tenth of a thickness of the sample carrier. Material and costs can be saved as a result, this being particularly advantageous in volume production.

Alternatively or additionally, the wall thickness between two points of the wall can vary at most by a factor of two. As a result, a variation in the wall thickness of a main body can be of a relatively minor design, so that manufacturing a centrifugable sample carrier can be designed to be even more cost-effective.

In one advantageous design embodiment it can be provided that the at least one fastening blade is formed by the wall of the main body. In this way, the fastening blade and the main body can be integrally configured, as a result of which the at least one fastening blade can be configured to be more stable, this potentially being advantageous for a service life of a centrifugable sample carrier. Additionally, manufacturing an integral main body, as just described, can also be more cost-effective, in particular even if more than one fastening blade is implemented.

The at least one fastening blade can in particular be formed on a periphery of the main body, which can facilitate incorporating the sample carrier on a corresponding mounting of a centrifuge.

In one advantageous design embodiment it can be provided that the at least one fastening blade extends at least over one half of a longitudinal extent of the sample carrier. A relatively large and stable fastening region of a sample carrier can be achieved in this way, this potentially being particularly advantageous in the case of centrifugations at relatively high rotating speeds.

In one advantageous design embodiment it can be provided that the at least one fastening blade is delimited by at least one clearance. In this way, a fastening blade can be configured to be even more deformable, which can allow latching as described above to be even more customer-friendly.

Furthermore, the at least one clearance can be configured so as to correspond to a construction element of a centrifuge mounting, as a result of which a centrifugable sample carrier can be held in a particularly stable manner in the centrifuge.

In one advantageous design embodiment it can be provided that the chambers of the arrangement are disposed in a star-shaped or intermeshing manner. As a result, the chambers of an arrangement of chambers as described above or claimed hereunder can preferably be connected by way of a central construction element (for example a chamber of the arrangement and/or a fluidic duct), and/or each chamber is connected to at least one other chamber of the arrangement. In this way, chambers of the fluidic system can be easily networked with one another such that an environmental sample can be moved from one chamber into another chamber of the arrangement over short distances. In this way, preferably complex methods and methods with several steps can be carried out, which can particularly improve the operation of centrifugable sample carriers.

Furthermore, in the case of a star-shaped and/or intermeshed arrangement, at least one chamber can function as an “emergency chamber”, as a result of which a particularly high failsafe performance can be guaranteed, which is advantageous.

In a further advantageous design embodiment it can be provided that the fluidic system has at least one arrangement of chambers which is stacked for example in one direction of a centrifugal force. The respective chambers can be able to be uniformly filled and/or emptied as a result of an arrangement of this type. In this way, a direction for the centrifugal force in relation to the sample carrier in which the stacked arrangement is oriented “from top to bottom” can be chosen by the stacked arrangement. This enables a sample volume to be readily divided into sub-volumes which are able to be used and/or are used for different subsequent process steps. The direction of the centrifugal force herein can correspond to the direction of the centrifugal force that arises during centrifugation of the sample carrier. For example, the direction of the centrifugal force (and thus a “top” and a “bottom”) in relation to the sample carrier can be slightly varied on account of a pivotability of the sample carrier on a plate of a centrifugation device.

These stacked arrangements can also be disposed for example mutually offset transversely to a stacking direction or be disposed directly below one another in the stacking direction.

For example, at least one chamber of the stacked arrangement can have a drain in the fluidic system, which represents an overflow in relation to an inflow of this chamber in the stacking direction. For example, this drain can open into the chamber following in the stacking direction. This enables a sample volume to be divided into sub-volumes in a simple manner. All chambers of the stacked arrangement are preferably designed in such a way, or the following inflows have corresponding branches, in order to fill the following chamber in the event of an overflow.

For example, it can be provided that a drain, for example the drain already mentioned, of a chamber of the stacked arrangement has a branch which opens into the following chamber in the stacked arrangement, on the one hand, and on the other hand into a further following chamber. In this way, a further overflow is able to be configured in a space-saving manner so as to achieve successive filling of the stacked arrangement.

It can also be provided that the drain has a branch which leads into the following chamber, on the one hand, and on the other hand into a further processing path. In this way, the further processing path is able to be filled by suitably changing the orientation of the centrifugal force, without further drains having to be configured on the following chamber.

It can be provided that individual or all chambers of the stacked arrangement have a further drain which, preferably in another relative orientation of a centrifugal force, opens or transitions into a specific processing path. This enables individual or all of the mentioned sub-volumes to be specifically or differently processed in a simple manner.

A plurality of stacked arrangements of chambers which are oriented in different directions can also be provided. The direction of the centrifugal force can be changed by rotating the sample carrier during centrifugation, so that another stacked arrangement can be filled and/or emptied.

In an advantageous design embodiment it can be provided that at least one wall of a chamber of the arrangement is concavely curved. In this way, a liquid can be moved slowly along the curved wall, as a result of which sensitive ingredients of the liquid can in particular be protected.

In particular, each chamber of the arrangement can have at least one concavely curved chamber. In this way, a transfer of liquid can be performed slowly and gently through the entire arrangement, which is advantageous.

In one advantageous design embodiment it can be provided that each chamber of the arrangement is connected to at least one other chamber of the arrangement by at least one fluidic duct. The chambers of the arrangement can be connected favorably in terms of structure and/or costs by a fluidic duct, this potentially being advantageous in particular in a star-shaped or intermeshed arrangement as described above and claimed hereunder.

In one advantageous design embodiment it can be provided that the arrangement has at least one central post, wherein the central post forms at least one wall of a first and a second chamber of the arrangement. A central post can form any shape so as to form at least one wall of a first and a second chamber. As a result, an arrangement of chambers can be produced variably and in a cost-effective manner.

A wall presented by the central post herein can also be configured in such a way that a liquid can flow in and/or off on said wall. In this way, the at least one wall of a chamber, which is formed by the central post, can form the protruding projection as described above or claimed hereunder. As a result, a central post can be utilized in many ways.

A high degree of variability can be achievable when the central post is moved into the or an arrangement by a plug connection just before the centrifugable sample carrier is completed. In this way, a specific central post, which can shape an arrangement in a specific manner, can be used depending on the requirement of the method and/or the requirement of the user. For example, a number of chambers in an arrangement can thus be determined by the choice of the central post. As a result, the or a centrifugable sample carrier can be variably designed in a particularly advantageous manner.

It can be provided in particular herein that at least two chambers are connected by a fluidic duct formed on the central post. In this way, a liquid can be rapidly transferred from one chamber into another chamber of the arrangement by way of the central post, which is advantageous.

In one advantageous design embodiment it can be provided that at least three chambers of the at least one arrangement open into a common connecting region. As a result, a relatively large connecting region which can transfer relatively large volumes at a minor pressure load on a fluidic system, in particular a micro-fluidic system, can advantageously be achieved. Furthermore advantageously, in a common connecting region there can be a faster transfer of liquid between the chambers that open into the connecting region.

The connecting region can be at least partially configured as a central post as described above, wherein networking of the chamber can be implemented in a cost-effective manner.

In one advantageous design embodiment it can be provided that each chamber of the at least one arrangement is connected to a measuring region. As a result, an environmental sample to be tested can advantageously be transferred from each chamber of the arrangement to a measuring region in order to be analyzed.

A connection of a chamber herein can be configured to be direct, preferably by way of a fluidic duct, and/or indirect, by way of a further chamber and/or a central post as described above or claimed hereunder. In this way, a connection between one chamber of the at least one arrangement and the measuring region can be designed to be particularly variable, as a result of which methods which in particular have several steps can be carried out in a centrifugable sample carrier.

In one advantageous design embodiment it can be provided that the at least one arrangement is connected to at least one further arrangement of chambers. As a result, even more complex methods can be carried out, which is advantageous.

Alternatively or additionally, the at least one arrangement can be connected to a further chamber. At least one further method step can advantageously be carried out in the further chamber. The further chamber can also be a waste chamber and/or holding chamber, as a result of which liquid from the at least one arrangement can be disposed of and/or kept ready. As a result of a connection between the at least one arrangement and at least one further chamber, reactions or methods on the centrifugable sample carrier can be designed to be particularly variable and adapted to requirements of users.

In one advantageous design embodiment it can be provided that a volume of the storage chamber is greater than a volume of the metering chamber at least by a factor of two. In this way, a metering chamber can be filled with a compensation substance multiple times, such that sequential filling of elements of a fluidic system that are connected to the metering chamber is advantageously able to be implemented.

In particular, a volume of the storage chamber can be greater than a volume of the metering chamber at least by a factor of five. As a result, a metering chamber can be filled with a compensation substance particularly often, such that sequential filling as described above can be carried out in a particularly efficient manner.

In general, the ratio between a volume of a storage chamber and a volume of a metering chamber can be adapted to specific analytical methods.

In one advantageous design embodiment it can be provided that a fluidic duct departing from the outlet opening has a siphon-type profile. It can be prevented as a result of the siphon-type profile that a liquid immediately flows away when filling the or a metering chamber. As a result, filling of elements of a fluidic system can be controlled, which may be particularly advantageous in the case of centrifugable sample carriers which can move about a second rotation axis.

In one advantageous design embodiment it can be provided that the storage chamber has a concavity protruding into the interior of the storage chamber. In this way, the storage chamber can at least partially be sub-divided into compartments, as a result of which a liquid and/or the previously described compensation substance can be held in a targeted manner in a specific compartment of the storage chamber, which is advantageous.

It can be provided in particular herein that a connecting line between the inlet opening of the storage chamber and an outlet opening of the storage chamber runs through the concavity. In this way, an undesirable outflow of a liquid and/or of the previously described compensation substance can be avoided even in the event of a rotation of a centrifugable sample carrier by 360° about its own rotation axis.

In one advantageous design embodiment it can be provided that aerating structures are formed between the storage chamber and the metering chamber. Aerating structures are understood to mean in particular aerating structures which are known to the person skilled in the art and are used in fluidic systems. Filling of a and/or the previously described metering chamber with a compensation substance can take place without bubbles by using aerating structures, which is advantageous for metering.

In one advantageous design embodiment it can be provided that the storage chamber is connected to a reservoir containing a compensation substance. As a result, the compensation substance can be kept ready in a reservoir until used. The reservoir herein can protect the compensation substance until the centrifugable sample carrier is used for analyzing microorganisms, for example. A durability of the centrifugable sample carrier can advantageously be extended as a result.

It can be provided in particular herein that the reservoir is configured as a pressure-activatable discharge device. In this way, the compensating substance can be released into the storage chamber by activating pressure, which is advantageous.

In one advantageous design embodiment it can be provided that an activation element for activating the pressure of the reservoir is formed between a depression and the reservoir. The reservoir herein can be at least partially positioned above a depression in which an activation element for activating the pressure is located. As a result, the activation element can advantageously be positioned in a space-saving manner in the centrifugable sample carrier, so that the fluidic system preferably does not have to be subjected to any spatial restriction.

The activation element can in particular be a mandrel. A mandrel can be configured in a particularly space-saving manner, which is advantageous.

Furthermore, the activation element, in particular the mandrel, for activating the pressure of the reservoir can be configured to be active and/or passive in order to activate the pressure. As a result, different activation elements can advantageously be adapted to centrifugable sample carriers of different types of configuration.

An active activation element can be configured as a movable mandrel.

A passive activation element can be an immovable mandrel, wherein the reservoir is pressed onto the mandrel, as a result of which the compensation substance is released from the reservoir.

In one advantageous design embodiment it can be provided that a connecting line between the inlet opening of the storage chamber and an outlet opening of the reservoir runs through the storage chamber. In this way, a connecting duct between the inlet opening of the storage chamber and the outlet opening of the reservoir can have at least one change of direction. It can be prevented as a result that a compensation substance runs from the outlet opening directly into the storage chamber by way of the inlet opening after the pressure of the reservoir has been activated. In this way, the storage chamber can be filled in a targeted manner with the compensation substance, preferably by a rotating movement of the centrifugable sample carrier, which is advantageous.

In one advantageous design embodiment it can be provided that a connecting line between the storage chamber and the reservoir runs through the metering chamber. In this way, the metering chamber can be formed between the reservoir and the storage chamber, as a result of which space can advantageously be formed on the centrifugable sample carrier.

The reservoir, the storage chamber and the metering chamber herein can be disposed in such a way that a transfer of a compensation substance can be transferred from the reservoir into the metering chamber by way of the storage chamber in stages, i.e. preferably as a function of an increasing rotation angle of a rotating centrifugable sample carrier. In this way, filling, in particular sequential filling as described above, of elements of a fluidic system that are connected to the metering chamber can be implemented even more efficiently.

In one advantageous design embodiment it can be provided that the cover element is configured to be transparent. A transparent cover element can be configured in such a way that an environmental sample located in the fluidic system can be recorded through the cover element. In this way, an optical pre-recording of an environmental sample can be carried out without the cover element having to be removed. It can thus be verified, for example, whether a sufficient quantity of microparticles have been collected for recording in a or the previously mentioned measuring region.

The transparent cover element can preferably be configured as a self-adhesive cover film.

A self-adhesive cover film can be of a very thin configuration so that even weak optical measuring signals can be recorded by a preferably optical detector. In this way, fluorescent microparticles, preferably microorganisms, can be detected by a detector, for example, despite the cover film being positioned between the microorganisms and the detector. It can furthermore be advantageous that a self-adhesive cover film can be removed from the measuring region relatively easily.

In one advantageous design embodiment it can be provided that the measuring region is at least partially formed by a cover which is fastenable to the fluidic system in a preferably force-fitting and/or form-fitting manner. A measuring region which is at least partially configured as a fastenable cover can advantageously be implemented after a main body, preferably as described above, has been completed. In this way, a measuring region cannot be damaged during the construction of the fluidic system and/or of the main body.

As a result of a force-fitting and/or form-fitting connection between a fastenable cover and the fluidic system, the centrifugable sample carrier can advantageously be configured for centrifugations and/or rotating movements.

Furthermore, there may also be different fastenable covers so that different measuring and/or recording regions can advantageously be attached to a specifically configured fluidic system of a centrifugable sample carrier in such a way that a model range of modular sample carriers can advantageously be implementable.

In one advantageous design embodiment it can be provided that the cover has a ventilation element. Ventilating the cover and/or the measuring region can be implemented in this way, which can be advantageous in particular when filling the measuring region.

The ventilation element is preferably a ventilation snorkel. The ventilation snorkel can be of a particularly long configuration and/or have an entry opening and an exit opening which are formed on different planes, as a result of which a particularly optimal and leakproof ventilation of the or of a measuring region can be configured.

In particular, a ventilation element can have thickenings on a periphery, as a result of which a larger area for a cover element, as previously described, for closing the measuring region can be provided.

In one advantageous design embodiment it can be provided that the cover element closes the ventilation element at least before measuring. As a result, the cover element can remain closed at least before measuring, as a result of which contaminations in the measuring region can be minimized or avoided.

In one advantageous design embodiment it can be provided that the cover element is connected to a preferably rotatable gripping element. As a result, the cover element can advantageously be removed from the measuring region by a gripping element. The cover element can in particular be removed from the measuring region by a rotatable movement component, as a result of which a self-adhesive cover film can in particular be pulled off the measuring region in a relatively simple manner.

### BRIEF DESCRIPTION OF THE DRAWINGS

The invention will now be described in more detail by means of exemplary embodiments, but is not limited to these exemplary embodiments. Further exemplary embodiments are derived by combining the features of individual or several claims with one another and/or with individual or several features of the exemplary embodiments.

In the figures:

FIG. 1 shows a sample carrier according to the invention,

FIG. 2 shows an arrangement of chambers of a sample carrier according to the invention,

FIG. 3 shows a chamber of a sample carrier according to the invention having two ventilation openings,

FIG. 4 shows a chamber of a sample carrier according to the invention having a protruding projection,

FIG. 5 shows a storage chamber of a sample carrier according to the invention,

FIG. 6 shows a reservoir of a sample carrier according to the invention,

FIG. 7 shows a view from above onto a measuring region of a sample carrier according to the invention without a cover element,

FIG. 8 shows a view from above onto a measuring region of a sample carrier according to the invention with a cover element,

FIG. 9 shows a schematic arrangement of a measuring chamber having a measuring region in a sample carrier according to the invention, wherein the measuring chamber is fluidically connected to two waste chambers, and

FIG. 10 shows a schematic arrangement of a sample carrier according to the invention, wherein the measuring chamber is fluidically connected to two waste chambers, and wherein a buffer chamber is disposed between the measuring chamber and a waste chamber.

FIG. 11 shows another embodiment of a sample carrier according to the invention with the measuring region located in a measuring chamber which as a separate component is able to be snapped or plugged into the sample carrier.

FIG. 12 shows another embodiment of a sample carrier according to the invention with two stacked arrangements of chambers.

### DETAILED DESCRIPTION

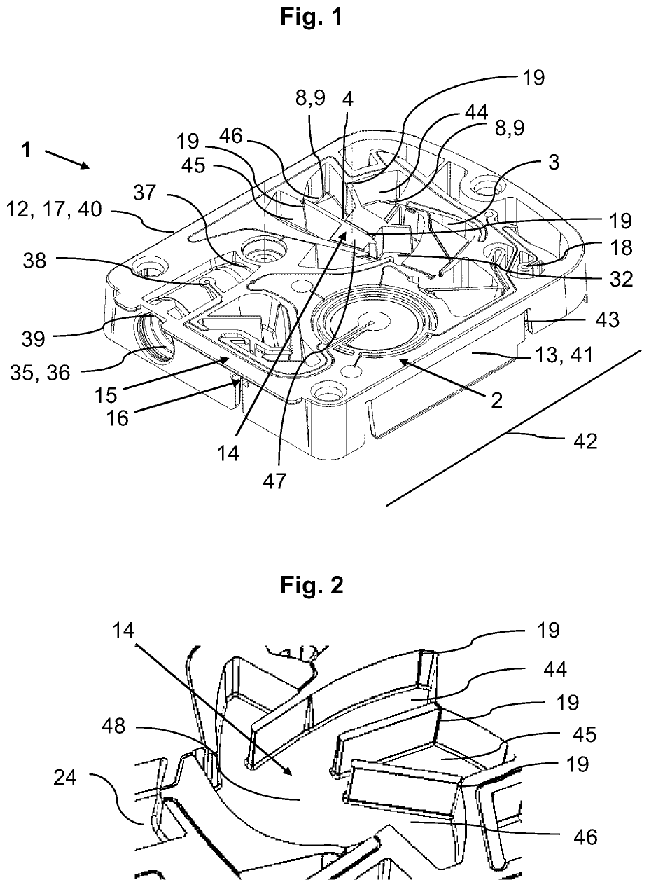

FIG. 1 shows a centrifugable sample carrier 1 according to the invention, which is suitable for analyzing microparticles, in particular for the fluorescence-based determination of microorganisms.

The centrifugable sample carrier 1 according to the invention in FIG. 1 has a fluidic system 2 with a plurality of chambers, inter alia the chambers 3, 20, 21, 32, 44, 45, 46, the latter having at least one inflow opening 4.

The centrifugable sample carrier 1 according to the invention has a main body 12 on which the fluidic system 2 is configured so as to be open toward one side. The open side is configured as a receptacle region 35 for a sampling instrument known to the person skilled in the art. In this way, an environmental sample can be incorporated into the fluidic system 2 by way of the receptacle region 35 and be analyzed.

A purging opening 38 is positioned at a spacing between an exit 36 of the receptacle region 35 and a drain 37 of the receptacle region 35. This purging opening 38 is connected to a reservoir 52 by way of a fluidic duct 19, as is shown in FIG. 6 and will be described hereunder. In this way, an environmental sample in the receptacle region 35 can advantageously be purged or diluted with a compensation substance, as a result of which an environmental sample can be protected and/or prepared for an analysis.

Receiving the environmental sample in the receptacle region 35 can be simplified in that a notch 39, which is located in the receptacle region 35, is configured to break off a sampling instrument. In this way, that part of the sampling instrument that is in contact with the environmental sample remains in the receptacle region 35 during the analysis. An environmental sample can advantageously be dissolved by the compensation substance by way of the purging opening 38 described in the above paragraph and claimed hereunder.

As is the case in the centrifugable sample carrier 1 according to the invention illustrated in FIG. 1, it can furthermore be provided that the notch 39 reliably retains that part of the sampling instrument that is located in the receptacle region 35 and positions it optimally relative to the drain 37.

By way of the drain 37, an environmental sample is transported onward within the fluidic system 2 during centrifugation.

At least one fastening blade 13 is attached to the main body 12 of the centrifugable sample carrier 1 according to the invention. One of two (mutually opposite) fastening blades 13 is shown in FIG. 1. The two fastening blades 13 are formed on a periphery 41 of the wall 40 of the main body 12 and serve to fasten the sample carrier 1 to a preferably precisely fitting mounting of a centrifuge. Furthermore, the fastening blades 13 are delimited by two clearances 43, as a result of which the fastening blades 13 can be configured to be relatively movable, fastening of the sample carrier 1 to a centrifuge being able to be simplified as a result. Because the fastening blades 13 extend over half of the longitudinal extent 42 of the sample carrier 1, the sample carrier 1 can be attached to a mounting of a centrifuge in a particularly simple manner and be held in a stable manner during the centrifugation. In this way, analyses of environmental samples in a sample carrier 1 according to the invention can be carried out even at high rotating speeds.

The wall 40 of the main body 12 of the sample carrier 1 illustrated in FIG. 1 delimits the fluidic system 2. The wall 40 herein is less than 10% of the thickness of the sample carrier 1, which can be particularly advantageous for the production of the sample carrier 1, in particular if the sample carrier 1 is produced by injection molding. Furthermore, the wall thickness of the wall 40 between two points varies at most by a factor of two.

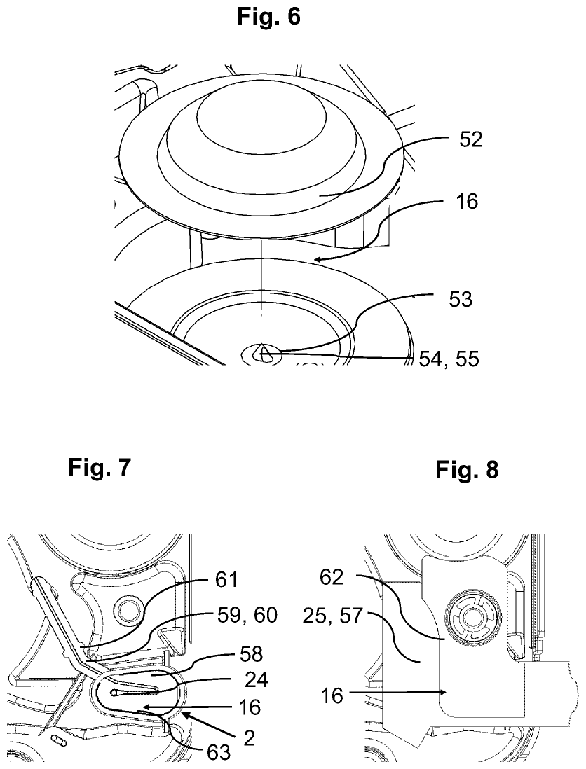

The centrifugable sample carrier 1 according to the invention in FIG. 1 has two sides 15, 16 which are advantageously separated by an encircling periphery 17. The fluidic system 2 comprises at least one connecting duct 18 which connects the two sides 15, 16. In this way, one end of the fluidic duct 19 can transition into the at least one connecting duct 18 on the upper side 15 of the sample carrier 1. On the lower side 16, the connecting duct 18 transitions into a fluidic duct 19 (not shown) which leads into a measuring region 24 illustrated in FIGS. 7 and 8 and described hereunder. In this way, a particularly large amount of space on both sides 15, 16 of the sample carrier 1 can be utilized in order to analyze an environmental sample.

As already explained, the centrifugable sample carrier 1 of FIG. 1 has a plurality of chambers 3, 20, 21, 32, 44, 45, 46. The chambers with the reference signs 32, 44, 45 and 46 are part of an arrangement 14 in which each chamber 32, 44, 45, 46 is adjacent at least to two further chambers of the arrangement 14. The further chambers herein comprise the chambers 32, 44, 45 and 46 and chambers not denoted by reference signs. In any case, the chambers of the arrangement 14 are arranged in a star-shaped manner, but may alternatively also be disposed so as to be intermeshed.

Each chamber 32, 44, 45 and 46 of the arrangement 14 has a wall which is concavely curved in such a way that an environmental sample and/or another liquid, in particular the previously mentioned compensation substance, can advantageously be transported through the chamber 32, 44, 45 and 46.

However, it may also be the case that only individual chambers of the arrangement 14, for example the chambers 32, 44, 45 and 46, have one or a plurality of curved walls. The design embodiment of the arrangement 14 and in particular of the walls can be adapted variably to customer requirements.

It can furthermore be seen in FIG. 1 that each chamber 32, 44, 45 and 46 of the arrangement 14 is connected to at least one other chamber 32, 44, 45 and 46 of the arrangement 14 by at least one fluidic duct 19. In this way, an environmental sample and/or another liquid, in particular the previously mentioned compensation substance, can be transported arbitrarily between the chambers 32, 44, 45 and 46. This is particularly advantageous in centrifuges in which a sample carrier, such as the sample carrier 1, is adjustable by preferably 360° on a second rotation axis. In this way, in particular methods with several steps and/or complex methods for determining microparticles, in particular microorganisms, can be carried out.

The arrangement 14 can have a central post 47 which forms at least one wall of a first and of a second chamber of the arrangement 14, as can be seen in FIG. 1. In this way, the central post 47 forms in each case one wall of the chambers 32, 44, 45 and 46, for example. It can furthermore be seen that, for example, the chamber 46 is advantageously connected to an antechamber 32 by way of a fluidic duct 19, wherein the fluidic duct 19 is formed on the central post 47.

Alternatively, an arrangement 14 of a sample carrier 1 may also have no central post 47 so that the chambers 44, 45, 46 open into a common connecting region 48, as is illustrated in FIG. 2. Production costs can be saved in this way, on the one hand, and an environmental sample and/or another liquid, in particular the previously mentioned compensation substance, can make its way relatively quickly by way of the connecting region 48 to the measuring region 24 which is connected to the arrangement 14, on the other hand. In the arrangement 14 illustrated in FIG. 2, each chamber is connected to the measuring region 24 by way of the connecting region 48.

Alternatively or additionally, it can be provided that a central post 47, in particular the central post 47 described above or claimed hereunder, can be fastened replaceably to the sample carrier 1. In this way, an arrangement 14 of chambers can be adapted in a customer-specific manner, which is advantageous. In this way, a model range of sample carriers 1 which preferably differ in terms of adaptable arrangements 14 can advantageously be achieved.

Arrangements 14 such as illustrated in FIGS. 1 and 2 can also be connected to at least one chamber that is not part of the arrangement 14. In this way, an arrangement 14 can be connected to a chamber 3 (FIG. 1) or to a chamber which comprises a measuring region, for example (FIG. 2).

Alternatively or additionally, it can be provided that an arrangement 14 is connected to a further arrangement 14 of chambers (not shown). In this way, in particular analytical methods with several steps and/or complex analytical methods can be carried out.

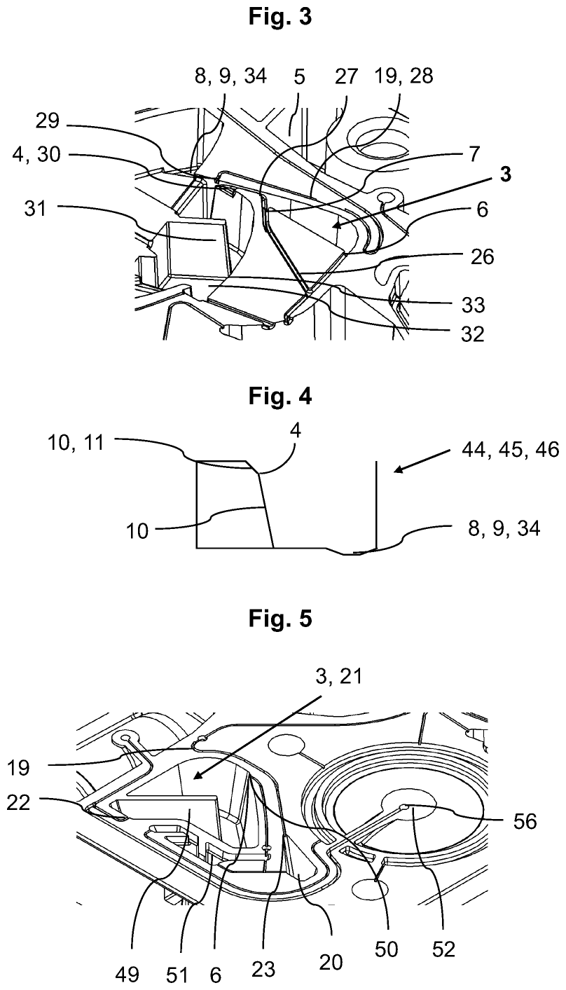

Described hereunder are individual embodiments of chambers 3, 20, 21, 32, 44, 45, 46 and elements of the sample carrier 1, which can be configured on a sample carrier 1 according to the invention, such as the sample carrier 1 of FIG. 1. Components and functional units which in terms of function and/or construction are equivalent or identical to the previous exemplary embodiments are provided with the same reference signs and are not separately described once again. Therefore, the explanations pertaining to FIGS. 1 to 2 apply in an analogous manner to FIGS. 3 to 8 and 11 to 12.

FIG. 3 shows a chamber 3, wherein the chamber 3 has two mutually spaced-apart ventilation openings 6, 7, the two ventilation openings 6, 7 being mutually disposed in such a way that a connecting line between the ventilation openings 6, 7 does not run through the chamber 3. In this way, the chamber 3 can be filled and ventilated in an optimal manner.

It can furthermore be seen in FIG. 3 that both ventilation openings 7 transition into a ventilation duct 26 which has a change of direction in its course. The ventilation duct 26 converges with a ventilation duct 26 of the ventilation opening 6 at an acute angle, so that space is advantageously saved on the fluidic system.

A corner 27 is advantageously formed between the inflow opening 4 and the ventilation openings 6, 7 of the chamber 3. The inflow opening 4 is formed below the ventilation openings 6, 7 so that no liquid can enter the ventilation openings 6, 7 when filling the chamber 3. A stable ventilation can be guaranteed by a construction of this type, so that a pressure in the chamber 3 can also be optimally maintained or adapted for an analytical method.

In order for the chamber 3 to be optimally filled with an environmental sample and/or another liquid, in particular the previously mentioned compensation substance, the inflow opening 4 can be configured as an inflow region 30, as shown in FIG. 3.

In the exemplary embodiment illustrated here, the overflow opening 28 is furthermore located above the inflow region 4, 30. The overflow opening 28 transitions into an overflow duct 19, 28 which has a siphon-type profile, as a result of which a return flow of an overflowing liquid can advantageously be prevented. The overflow duct 19, 28 connects the chamber 3 to a waste chamber 5 and/or a holding chamber, so that liquid can advantageously be disposed of and/or held.

The chamber 3 is advantageously connected to an antechamber 32 (FIGS. 1 and 3). The antechamber 32 has a friction wall 33 with a gradient decreasing toward the inflow opening 4, so that an environmental sample and/or another liquid, in particular the previously mentioned compensation substance, can be transferred gently into the chamber 3. Furthermore, the antechamber 32 has a concavity 31 which protrudes into the interior of the antechamber 32.

A chamber of the fluidic system 2, in particular the chamber 3 from FIGS. 1 and 3, most particularly the chambers 32, 44, 45, 46 of the arrangement 14 (FIG. 1) can have a depression 9 in the base 8. The depressions 8, 9 in FIG. 1 in a centrifugable sample carrier 1 are optimally disposed opposite an inflow opening 4 (cf. chamber 46, for example). In the process, an environmental sample and/or another liquid, in particular the previously mentioned compensation substance, can advantageously be held in the depression 8, 9, in particular during a method step (cf. FIG. 3). Furthermore, a dried substance 34 which is important for a method can be kept ready in the depression 8, 9 (FIGS. 3 and 4), which is activated when an environmental sample is guided into the depression 8, 9, for example. In this way, a spatially defined reaction space can be achieved by the depression 8, 9, as a result of which method steps can be carried out in an optimal manner.

The chambers 44, 45 and 46 illustrated in FIG. 1 have a wall 10 with a protruding projection 11. A wall 10 of this type, having a protruding projection 11, is schematically illustrated in FIG. 4. As can be seen in FIG. 4, a runoff edge is formed on the protrusion 11, and the inflow opening 4 is disposed between a dripping edge and an impact point of a pouring jet defined by the runoff edge. The minimum spacing of the depression 8, 9 from the inflow opening 4 is greater than the minimum spacing of the depression 8, 9 from a foot of the wall 10, as a result of which a liquid can be incorporated in the direction of the depression 8, 9 in a particularly gentle manner.

FIG. 5 shows a storage chamber 21 of a sample carrier 1 according to the invention, wherein a connecting line between the inlet opening 22 of the storage chamber 21 and the outlet opening 23 of the metering chamber 20 runs through the storage chamber 21.

It can furthermore be seen in FIG. 5 that the volume of the storage chamber 21 is larger than the volume of the metering chamber 20 at least by a factor of five. Repeated metering of individual chambers, in particular the chambers 3, 32, 44, 45, 46, 63, is possible in particular as a result of these different volumes. It is guaranteed by the concavity 49 of the storage chamber 21, which protrudes into the interior of the storage chamber 21, and a connecting line between the inlet opening 22 of the storage chamber 21 and an outlet opening 50 of the storage chamber 21 running through the concavity 49, that liquid cannot flow back by way of the inlet opening 22. As a result of the configuration of the embodiment with a storage chamber 21 and a metering chamber 20, shown in FIGS. 1 and 5, optimal metering of the elements of the fluidic system 2 disposed downstream of the metering chamber 20 can be achieved.

The metering is furthermore optimized because a fluidic duct 19 departing from the outlet opening 23 has a siphon-type profile (cf. FIG. 5).

The metering is furthermore optimized because aeration structures 51 are formed between the storage chamber 21 and the metering chamber 20 (cf. FIG. 5). In this way, a liquid, in particular the previously described compensation substance, can be transferred without bubbles into the elements of the fluidic system 2 that are disposed downstream of the metering chamber 20. Analytical methods can be implemented even more precisely by minimizing or even avoiding bubbles.

The previously mentioned compensation substance for metering is located in a reservoir 52 which is connected to the storage chamber 21. It can be seen in FIG. 5 that a connecting line between the inlet opening 22 of the storage chamber 21 and an outlet opening 56 of the reservoir 52 runs through the storage chamber 21. As a result of this arrangement of the chambers 20, 21 and the reservoir 52, the fluidic system can be filled in a particularly accurate manner without liquid and/or an environmental sample being lost, even when the sample carrier is rotated by 360°.

As can be seen in the exploded illustration of FIG. 6, the reservoir 52 located on the lower side 16 of the sample carrier 1 is pressure-activatable. The activation element 54 illustrated in this embodiment is configured as a mandrel 55 and positioned between a depression 53 and the reservoir 52.

The measuring region 24, which is located on the lower side 16 of the sample carrier 1, will be described in more detail hereunder (cf. FIGS. 7 and 8). The measuring region 24 is closed by a removable cover element 25 (cf. FIG. 8). The removable cover element 25 can advantageously be removed from the measuring region 24 at least during a recording, so that even particularly weak measuring signals can be recorded. In this way, fluorescent microorganisms which would not be detectable, or only detectable with difficulty, through a cover element 25, can be detected, for example. In this way, microorganisms of an environmental sample can be analyzed and quantified, for example.

It is advantageous for the cover element 25 to be configured to be transparent, as is the case in the exemplary embodiment of FIG. 8. In this way, analyses that do not require removal of the cover element 25 can also be performed. An environmental sample can be better and longer protected as a result.

Furthermore, the cover element 25 shown in FIG. 8 is configured as a self-adhesive cover film 57 and thus relatively easy to remove from the measuring region 24. The cover film 25, 57 can be removed in a particularly simple manner if the cover film 25, 57 is connected to a rotatable gripping element 62, as is the case in the embodiment as per FIG. 8. In this way, the cover film 25, 57 can be removed from the measuring region 24 by a rotating movement of the gripping element 62.

The measuring region 24 per se can be at least partially formed by a cover 58 which is fastenable to the fluidic system 2 in a preferably force-fitting and/or form-fitting manner (cf. FIG. 7). The cover 58 in FIG. 7 is fixedly plugged onto the fluidic system 2 and in this way, conjointly with the fluidic system 2, forms the measuring region 24. The measuring region 24 is connected to elements of the fluidic system 2 that are located on the upper side 15 of the sample carrier 1 by way of a connecting duct 18 shown in FIG. 1.

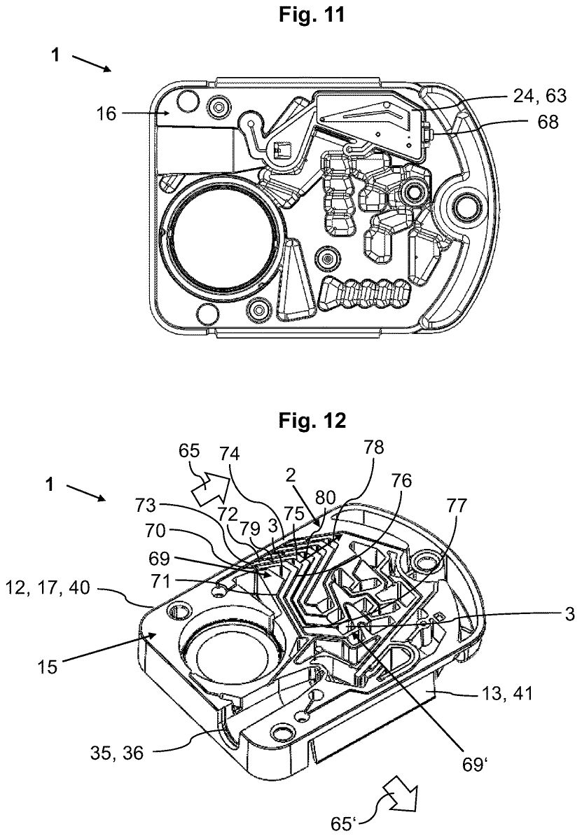

Alternatively, as is shown in FIG. 11, the measuring region 24 can also be located in a measuring chamber 63 which as a separate component is able to be snapped or plugged into the sample carrier 1. For this purpose, the measuring chamber 63 is releasably connectable to the sample carrier by way of a snap-fit closure 68 on the lower side 16 of the sample carrier 1. This offers the advantage, for example, that the measuring chamber 63 can be separately disposed of and/or stored after the analysis. A releasable measuring chamber 63 also makes it possible, for example, that the latter can be replaced, or different measuring chambers 63 can be used depending on the requirement.

For optimal analytical methods, the measuring region 24 is ventilated by way of a ventilation element 59. The ventilation element 59 in the embodiment as per FIG. 7 is advantageously configured as a ventilation snorkel 60 of the cover 58 and protrudes without interference into the interior of the sample carrier 1. The ventilation snorkel 60 here has thickenings 61 which are optimally configured for fastening the cover element 25, 57 (cf. FIG. 8). Furthermore, the ventilation element 59, 60 in this way is closed by the cover element 25, 57 at least before measuring.

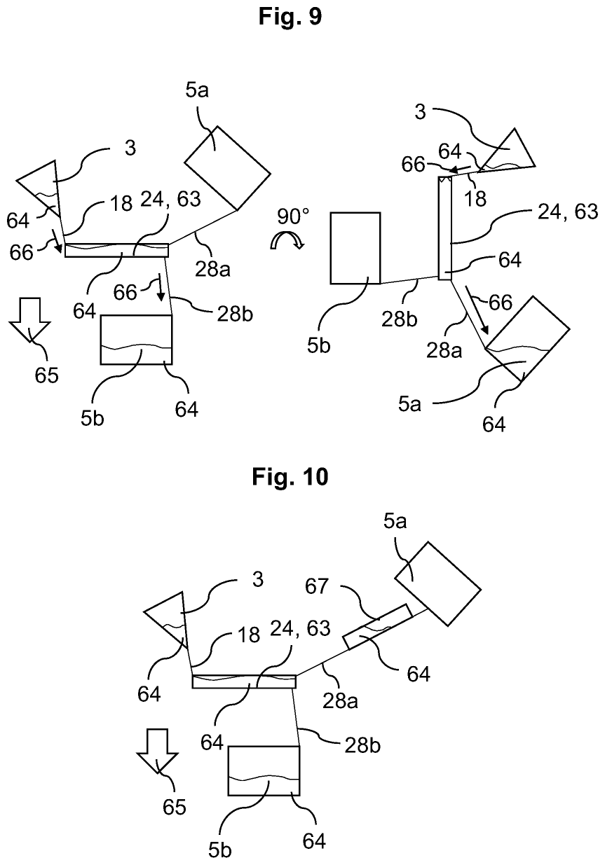

FIG. 9 shows a schematic arrangement of a measuring chamber 63 having a measuring region 24 in a sample carrier 1 according to the invention, wherein the measuring chamber 63 is fluidically connected to two waste chambers 5a, 5b. The overflow duct 28a that leads to the first waste chamber 5a of the at least two waste chambers 5a, 5b herein opens out on a side of the measuring region 24, 63 other than the overflow duct 28b of the second waste chamber 5b of the at least two waste chambers 5a,b.

In this way, the sample carrier 1 during the centrifugation can be pivoted by 90° counter to its centrifugal force 65, as is illustrated in FIG. 9. In this way, the liquid 64 is located in the chamber 3 before pivoting (left side). From there, the liquid 64 flows by way of the connecting duct 18 into the measuring chamber 63 and from there onward into the waste chamber 5b. The flow path 66 of the liquid 64 is represented by arrows in FIG. 9. This is possible in particular because the waste chamber 5a is connected in front of the measuring region 24 in a processing direction, thus the direction of the centrifugal force 65, and the waste chamber 5b is connected behind the measuring region 24 in the processing direction.

After pivoting (right side of FIG. 9), the flow path 66 changes to the extent that the liquid 64 no longer flows into the waste chamber 5b but into the waste chamber 5a. In this way, the measuring region 24, 63 can be fed sequentially with a plurality of preferably different liquids 64 without mixing of the liquids 64 taking place in the measuring region 24, 63. Furthermore, a backlog in the measuring region 24, 63 can be prevented. Analyses or measurements of samples can in particular be improved in this way.

As can be seen in FIG. 9, the chamber 3 and the waste chambers 5a are disposed in such a way that no liquid 64 can make its way from the chamber 3 into the waste chamber 5a before pivoting. After pivoting (right side) the waste chamber 5a forms the outermost point of the fluidic system 2. This embodiment is particularly preferable because a backlog in the measuring region 24, 63 can advantageously be prevented.

FIG. 10 shows a schematic arrangement of a sample carrier 1 according to the invention, wherein the measuring chamber 63 is fluidically connected to two waste chambers 5a, 5b, and wherein a buffer chamber 67 is disposed between the measuring chamber 63 and the waste chamber 5a. In this way, a crossflow as described herein can be formed, which can advantageously be utilized for a crossflow filtration. Blocking of the membrane, or of the measuring region 24, 63, can be decelerated or even prevented by the crossflow. Furthermore, the crossflow can in particular be utilized to accelerate reactions on the membrane so that analyses of samples can be improved.

FIG. 12 shows an embodiment of a sample carrier 1 according to the invention, in which two stacked arrangements 69, 69′ of chambers 3 can be seen. The stacked arrangements 69, 69′ are oriented in respectively different directions of a centrifugal force 65, 65′.

If the sample carrier 1 during centrifugation is oriented in such a way that the centrifugal force 65 is directed in the direction of the first stacked arrangement 69, the chambers 3 of the first stacked arrangement 69 can be uniformly filled. If the sample carrier 1 is thereafter rotated and oriented in such a way that the centrifugal force 65′ arising during the centrifugation is oriented in the direction of the second stacked arrangement 69′, the chambers 3 of the first stacked arrangement 69 can be emptied, and the chambers 3 of the second stacked arrangement 69′ are simultaneously filled.

As a result of such stacked arrangements 69, 69′ it is possible that the respective chambers 3 can be uniformly and/or simultaneously filled and/or emptied.

The stacked arrangement 69, 69′ herein defines in each case a stacking direction 78 which defines the terms “top” and “bottom” when the centrifugal force 65 is oriented in a corresponding manner.

The chamber 3 of the stacked arrangement 69, 69′ herein has an inflow 71 and a drain 70. The drain 70 in terms of the stacking direction 78 forms an overflow 72 in relation to the inflow 71 (when the centrifugal force 65 is oriented in a corresponding manner). This overflow 72 opens into the following chamber 75 of the stacked assembly 69. As soon as the chamber 3 is filled, liquid that flows into the chamber 3 by way of the inflow 70 will flow into the following chamber 75 and fill the latter, etc. The drain 70 herein has a further branch 79 which leads to the chamber 75, on the one hand, and to the further following chamber 80, on the other hand. As soon as the chamber 75 is filled, this branch 79 acts as an overflow leading into the chamber 80.

In this way, a large volume of liquid is divided into many sub-volumes.

A branch 73 to a processing path 74 makes it possible for all chambers 3 of the stacked arrangement 69 to be conjointly emptied when the direction of the centrifugal force 65 changes in a corresponding manner.

The chamber 75 has a further drain 76 which opens or transitions into a processing path 77 that is specific to this chamber 75. By changing the orientation of the centrifugal force 65 it can thus be achieved that the sub-volumes are processed separately from one another and/or differently.

The invention thus preferably proposes a centrifugable sample carrier 1 having a fluidic system 2, the fluidic system having at least one chamber 3, 20, 21, 32, 44, 45, 46, 63 which has at least one inflow opening 4, the chamber 3, 20, 21, 32, 44, 45, 46, 63 having at least two mutually spaced-apart ventilation openings 6, 7, and the ventilation openings 6, 7 being mutually disposed in such a way that a connecting line between the ventilation openings 6, 7 does not run through the chamber 3, 20, 21, 32, 44, 45, 46, 63. A sample carrier 1 of this type according to the invention is particularly suitable for use in analytical methods for detecting microorganisms, but is not restricted to this use.

### LIST OF REFERENCE SIGNS

1 Centrifugable sample carrier
2 Fluidic system
3 Chamber
4 Inflow opening
5 Waste chamber
6 Ventilation opening of 3
7 Ventilation opening of 3
8 Base
9 Depression
10 Wall
11 Projection
12 Main body
13 Fastening blade
14 Arrangement of chambers
15 Side of the sample carrier
16 Side of the sample carrier
17 Periphery
18 Connecting duct
19 Fluidic duct
20 Metering chamber
21 Storage chamber
22 Inlet opening of 21
23 Outlet opening of 20
24 Measuring region
25 Removable cover element
26 Ventilation duct
27 Corner
28 Overflow duct
29 Overflow opening
30 Inflow region
31 Concavity
32 Antechamber
33 Friction wall of 32
34 Dried substance
35 Receptacle region
36 Exit of 35
37 Drain of 35
38 Purging opening of 35
39 Notch
40 Wall of 12
41 Periphery of 12
42 Longitudinal extent of 1
43 Clearance
44 Chamber of 14
45 Chamber of 14
46 Chamber of 14
47 Central post
48 Connecting region
49 Concavity of 21
50 Outlet opening of 21
51 Aerating structures
52 Reservoir
53 Depression
54 Activation element
55 Mandrel
56 Outlet opening of 52
57 Cover film
58 Cover
59 Ventilation element
60 Ventilation snorkel
61 Thickenings of 59
62 Gripping element
63 Measuring chamber
64 Liquid
65 Centrifugal force
66 Flow path of 64
67 Buffer chamber
68 Snap-fit closure
69 Stacked arrangement of chambers
70 Drain
71 Inflow
72 Overflow
73 Branch
74 Processing path
75 Following chamber
76 Further drain
77 Specific processing path
78 Stacking direction
79 Branch
80 Chamber

1. A centrifugable sample carrier (1), comprising:
a fluidic system (2) which has at least one chamber (3, 20, 21, 32, 44, 45, 46, 63), the chamber (3, 20, 21, 32, 44, 45, 46, 63) having at least one inflow opening (4), and the chamber (3, 20, 21, 32, 44, 45, 46, 63) having at least two mutually spaced-apart ventilation openings (6, 7), wherein the ventilation openings (6, 7) are mutually disposed such that a connecting line between the ventilation openings (6, 7) does not run through the chamber (3, 20, 21, 32, 44, 45, 46, 63).

2. The centrifugable sample carrier (1) as claimed in claim 1, wherein the at least one chamber (3, 20, 21, 32, 44, 45, 46, 63) has a base (8) in which a depression (9) is formed.

3. The centrifugable sample carrier (1) as claimed in claim 1, wherein a wall (10) of the chamber (3, 20, 21, 32, 44, 45, 46, 63) forms a projection (11) protruding into the chamber (3, 20, 21, 32, 44, 45, 46, 63), a runoff edge is formed on the projection (11), and the inflow opening (4) is disposed between a dripping edge and an impact point of a pouring jet defined by the runoff edge.

4. The centrifugable sample carrier (1) as claimed in claim 1, further comprising a main body (12) on which the fluidic system (2) is configured so as to be open toward one side, and the main body (12) comprising at least one fastening blade (13).

5. The centrifugable sample carrier (1) as claimed in claim 1, wherein the at least one chamber includes a plurality of the chambers, and the fluidic system (2) includes at least one arrangement (14) of the chambers (3, 20, 21, 32, 44, 45, 46, 63), wherein each said chamber (3, 20, 21, 32, 44, 45, 46, 63) of the at least one arrangement (14) is adjacent to at least two further ones of the chambers (3, 20, 21, 32, 44, 45, 46, 63) of the at least one arrangement (14).

6. The centrifugable sample carrier (1) of claim 1, further comprising two sides (15, 16) which are separated by an encircling periphery (17), the fluidic system (2) comprising a connecting duct (18) which connects the two sides (15, 16), and the connecting duct (18) at the ends thereof transitions into in each case one fluidic duct (19) running along one of the two sides.

7. The centrifugable sample carrier (1) as claimed in claim 1 wherein the fluidic system (2) has at least one metering chamber (20) and a storage chamber (21), and a connecting line between an inlet opening (22) of the storage chamber (21) and an outlet opening (23) of the metering chamber (20) runs through the storage chamber (21).

8. The centrifugable sample carrier (1) as claimed in claim 1, wherein the fluidic system (2) has at least one measuring region (24), and the measuring region (24) is closed by a removable cover element (25).

9. The centrifugable sample carrier (1) as claimed in claim 9, wherein the measuring region (24) is at least one of: located in a measuring chamber (63), or connected to at least two waste chambers (5, 5a, 5b), one of the at least two waste chambers (5, 5a, 5b) being connected in front of the measuring region (24) in a processing direction, and/or one of the at least two waste chambers (5, 5a, 5b) being connected behind the measuring region (24) in a processing direction, and an overflow duct (28, 28a, 28b) that leads to the first waste chamber (5) of the at least two waste chambers (5, 5a, 5b) opens out on a side of the measuring region (24) other than the overflow duct (28, 28a, 28b) of the second waste chamber (5) of the at least two waste chambers (5).

10. The centrifugable sample carrier (1) as claimed in claim 9, wherein the measuring chamber (63) is releasably connectable to the sample carrier (1).

11. The centrifugable sample carrier (1) as claimed in claim 10, further comprising a buffer chamber (67) disposed in fluidic connection between at least one of the at least two waste chambers (5, 5a, 5b), and at least one of the ventilation openings (6, 7) transitions into a ventilation duct (26) which has a change of direction in its course.

12. The centrifugable sample carrier (1) as claimed in claim 1, wherein the at least two ventilation openings (6, 7) converge, the chamber (3) has at least one overflow opening (29) which transitions into an overflow duct (28), the overflow opening (28) being positioned above the inflow opening (4), and the inflow opening (4) is formed as an inflow region (30).

13. The centrifugable sample carrier (1) as claimed in claim 1, further comprising at least one fluidic duct (19) connected to the chamber (3) has a siphon-type profile, and the chamber has at least one concavity (31) protruding into an interior of the chamber (3), the at least one inflow opening (4) and/or the at least one ventilation opening (6, 7) being positionable between the concavity (31) and a centrifugal axis.

14. The centrifugable sample carrier (1) as claimed in claim 1, wherein the at least one chamber (3, 20, 21, 32, 44, 45, 46, 63) has a base (8) in which a depression (9) is formed, the depression (9) is disposed opposite an inflow opening (4), and/or is disposed in the chamber (3) defined by a wall (10) such that a minimum spacing of the depression (9) from the inflow opening (4) is greater than a minimum spacing of the depression (9) from the wall (10).

15. The centrifugable sample carrier (1) as claimed in claim 1, wherein an open side of the fluidic system is formed as a receptacle region (35) for a sampling instrument, with a purging opening (38) being positioned at a spacing between an exit (36) of the receptacle region (35) and a drain (37) of the receptacle region (35).

16. The centrifugable sample carrier (1) as claimed in claim 1, further comprising a main body (12) having at least one fastening blade (13). the fastening blade (13) at least one of a) is formed by a wall (40) of the main body (12), b) extends at least over one half of a longitudinal extent (42) of the sample carrier (1), or c) is delimited by at least one clearance (43).

17. The centrifugable sample carrier (1) as claimed in claim 1, wherein the at least one chamber includes a plurality of chambers, and the fluidic system (2) has at least one arrangement (69) of the chambers (3) which is stacked in a direction of a centrifugal force (65), and at least one of the chambers (3) of the stacked arrangement (69, 69′) having a drain (70) which at least one of a) forms an overflow (72) in a stacking direction (78) in relation to an inflow (71) of this chamber (3), b) opens into the chamber (75) that follows in the stacking direction (78), or has a branch (73) to the following chamber (75) and a further processing path (74) or a further following chamber (80).

18. The centrifugable sample carrier (1) as claimed in claim 1, wherein the at least one chamber includes a plurality of the chambers, and the fluidic system (2) includes at least one arrangement (14) of the chambers, at least one wall of one said chamber of the arrangement (14) is concavely curved, each said chamber of the arrangement (14) is connected to at least one other one of the chambers of the arrangement (14) by at least one fluidic duct (19), and the arrangement (14) has at least one central post (47), the central post (47) forming at least one wall of a first one of the chambers and of a second one of the chambers of the arrangement (14).

19. The centrifugable sample carrier (1) as claimed in claim 18, wherein at least three chambers of the arrangement (14) open into a common connecting region (48), and each chamber is connected to a measuring region (24), and the arrangement (14) is connected to at least one further arrangement of chambers.

20. The centrifugable sample carrier as claimed in claim 7, wherein a volume of the storage chamber (21) is larger than a volume of the metering chamber (20) at least by a factor of two, wherein a fluidic duct (19) departing from the outlet opening (23) has a siphon-type profile, the storage chamber (21) has a concavity (49) protruding into an interior of the storage chamber (21), and a connecting line extends between the inlet opening (22) of the storage chamber (21) and an outlet opening (50) of the storage chamber (21) and runs through the concavity (49).

21. The centrifugable sample carrier (1) as claimed in claim 20, further comprising aerating structures (51) formed between the storage chamber (21) and the metering chamber (20), the storage chamber (21) is connected to a reservoir (52) containing a compensation substance, and an activation element (54) for activating the pressure of the reservoir (52) is formed between a depression (53) and the reservoir (52).

22. The centrifugable sample carrier (1) as claimed in claim 21, wherein a connecting line between the inlet opening (22) of the storage chamber (21) and an outlet opening (56) of the reservoir (52) runs through the storage chamber (21), and a connecting line between the storage chamber (21) and the reservoir (52) runs through the metering chamber (20).

23. The centrifugable sample carrier (1) as claimed in claim 19, wherein the measuring region (24) is at least partially formed by a cover (58) which is fastenable to the fluidic system (2), and the cover (58) has a ventilation element (59) that includes thickenings (61) on a periphery, and a cover element (25) closes the ventilation element (59) at least before measuring.

24. The centrifugable sample carrier (1) as claimed in claim 23, wherein the cover element (25) is connected to a rotatable gripping element (62).
